(19) United States
(12) Patent Application Publication
(10) Pub. No.: US 2015/0105958 A1
(43) Pub. Date: Apr. 16, 2015

(54) METHOD FOR CONTROLLING AN INTERNAL COMBUSTION ENGINE AND AN E-MACHINE OF AN HYBRID ELECTRICAL VEHICLE

(71) Applicants: Rainer SCHNURR, Stuttgart (DE); Juergen BIESTER, Boeblingen (DE); Michael GLORA, Markgroeningen (DE); Stefan Andreas KNIEP, Hildesheim (DE); Joerg HEYSE, Besigheim (DE)

(72) Inventors: Rainer SCHNURR, Stuttgart (DE); Juergen BIESTER, Boeblingen (DE); Michael GLORA, Markgroeningen (DE); Stefan Andreas KNIEP, Hildesheim (DE); Joerg HEYSE, Besigheim (DE)

(73) Assignee: Robert Bosch GmbH, Stuttgart (DE)

(21) Appl. No.: 14/515,257

(22) Filed: Oct. 15, 2014

(30) Foreign Application Priority Data
Oct. 16, 2013 (DE) 10 2013 220 929.0

(51) Int. Cl. B60W 10/06; B60W 20/00; B60W 10/08

(52) U.S. Cl. CPC B60W 10/06; B60W 10/08; B60W 20/00; Y10S 903/93
USPC 701/22; 180/65.265; 180/65.28; 180/65.285; 903/930

(57) ABSTRACT

A method for controlling an internal combustion engine and an E-machine of a hybrid electrical vehicle. In this case, the control of the internal combustion engine takes place as a function of a current and an expected waste heat of an electrical drive of the hybrid electrical vehicle.

### RELATED APPLICATION INFORMATION

The present application claims priority to and the benefit of German patent application no. 10 2013 220 929.0, which was filed in Germany on Oct. 16, 2013, the disclosure of which is incorporated herein by reference.

### FIELD OF THE INVENTION

The present invention relates to a method for controlling an internal combustion engine and an E-machine of an hybrid electrical vehicle Furthermore, the present invention relates to a computer program which carries out all the steps of the method according to the present invention, when it is run on a computer or control unit, as well as a data carrier which stores this computer program. Finally, the present invention relates to a control unit which is developed to carry out the method according to the present invention.

### BACKGROUND INFORMATION

An hybrid electrical vehicle (HEV) is a motor vehicle which is driven by at least one electrical drive and an additional energy converter, and obtains the energy from an operating fuel tank and a storage device for electric power. The electrical drive of an hybrid electrical vehicle is made up of an E-machine and an inverter. It has one or more characteristics curves which describe the dependence of the torque or a power output on the rotational speed. These apply for certain operating conditions and installation conditions of the electrical drive. If the actual conditions deviate from them, reduction factors are used by which the admissible torque has to be lowered in order to protect the drive components from thermal damage. This is referred to as derating. Derating is carried out in known operating strategies for electrical drives of hybrid electrical vehicles under high loads that last over longer times, based on the heating of the electrical drive, with respect to its driving power. When a derating is carried out, however, the motor vehicle has less propulsive power available for critical driving maneuvers, such as passing processes and for sportive driving.

### SUMMARY OF THE INVENTION

In the method according to the present invention, for controlling an internal combustion engine of an hybrid electrical vehicle, the control of the internal combustion engine takes place as a function of a current and an expected waste heat of an electrical drive of the hybrid electrical vehicle. Upon overheating, expected in the future, of the electrical drive as a result of longer lasting loads, this makes possible an unloading of the electrical drive in response to previous partial loads by setting higher priorities of the drive of the internal combustion engine.

That is, the internal combustion engine unloads the electrical drive, as a precautionary measure, at operating points at which a low propulsive power of the vehicle is required, in order subsequently, at maximum required propulsive power, that is, a propulsive power which is provided simultaneously by the electrical drive and the internal combustion engine, to be able to call up, for the time required, the full drive power of the electrical drive. The maximum propulsive power of the hybrid electrical vehicle is thus available in its entire operation, without thereby leading to thermal damage of the electrical drive. It is thereby ensured that a torque reserve is available for passing processes, which increases the traffic safety of the vehicle. At the same time, sporty driving is possible, so that the driving pleasure is enhanced.

The determination of the current waste heat of the electrical drive may take place by measuring at least one critical component temperature in the E-machine and/or in an inverter of the electrical drive. By a critical component temperature one may understand, according to the present invention, the temperature of a component of the E-machine or of the inverter, which is able to suffer thermal damage in response to the exceeding of a certain value of the critical component temperature.

The expected waste heat of the electrical drive may be ascertained by converting a load profile of a predicted travel route, supported by an efficiency characteristics map. The predicted travel route is ascertained particularly by an horizon provider. According to the present invention, by horizon provider one may understand any system that provides digital map data. The horizon provider makes available an electronic horizon. By this, one may understand, according to the present invention, a model which represents, among other things, topological and geographic conditions in the surroundings of the vehicle. The horizon provider may be a navigation system of the hybrid electrical vehicle, for example.

The most probable route of travel, inclusive of alternative possibilities, may be ascertained by the horizon provider.

It may further be that the load profile is determined using a speed profile, that is estimated based on data of the electronic horizon, by which a driving resistance equation is determined, at least the following parameters being taken into account: the vehicle mass of the hybrid electrical vehicle, its rolling resistance coefficient, its resistance to flow coefficient, the projected frontal area of the hybrid electrical vehicle and the density of the air surrounding the hybrid electrical vehicle. In this case, it quite particularly may be that, in the calculation of the rolling resistance coefficient, the type of road-surface covering be taken into account via which the hybrid electrical vehicle is traveling, the data on the road-surface covering being provided by the electronic horizon.

In addition, the predicted travel route may be ascertained based on a plurality of stored travel routes that have already been traveled. This is basically also possible when no horizon provider is available, but this may be combined with the use of an horizon provider.

The method according to the present invention enables a torque subdivision between the internal combustion engine and the E-machine. This may be updated at specified time intervals.

The computer program according to the present invention enables implementing the method according to the present invention in a control unit that is already present, without this requiring structural changes. For this purpose, it carries out all the steps of the method according to the present invention when it is run on a computing element or a control unit. The data carrier according to the present invention stores the computer program according to the present invention. The control unit according to the present invention is obtained by playing the computer program according to the present invention onto the control unit, which is developed to control an internal combustion engine of an hybrid electrical vehicle using the method according to the present invention.

An exemplary embodiment of the present invention is represented in the drawing and explained in greater detail in the following description.

### BRIEF DESCRIPTION OF THE DRAWING

The FIGURE shows a flow chart of a method according to an exemplary embodiment of the present invention.

### DETAILED DESCRIPTION

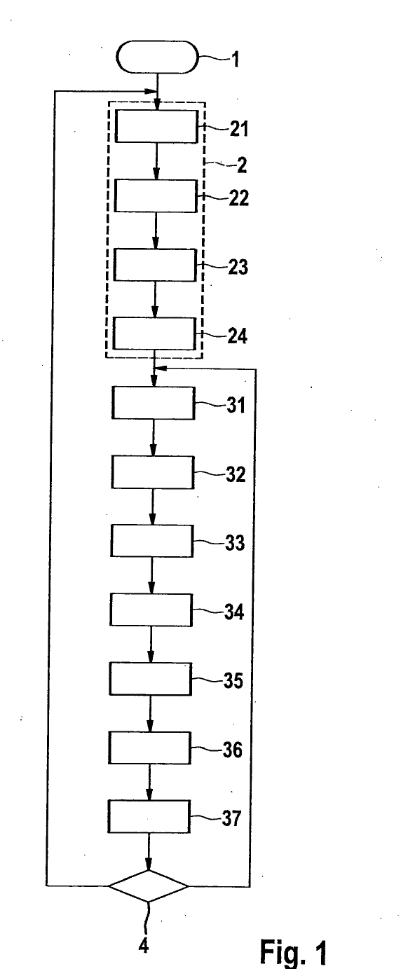

In an exemplary embodiment of the method, according to the present invention, for controlling an internal combustion engine of an hybrid electrical vehicle, which is shown schematically in FIG. 1, the method is started in a first method step 1. This is followed by a data supply step 2. In the latter step, in a substep 21, the expected route to be covered is ascertained. For this purpose, an electronic horizon is fed from the data of a digital navigation map of the hybrid electrical vehicle. The data are sent by the navigation system of the hybrid electrical vehicle, as horizon provider, using transmission protocol ADASIS (Advanced Driver Assistance System Interface Specification) via the CAN bus of the hybrid electrical vehicle to its inverter control unit. The horizon provider ascertains the route which the driver will probably select. This route is designated as Most Probable Path (MPP).

In the electronic horizon, the expected destination of travel is also shown, such as by indicating the expected residual travel time to reaching the destination and/or by marking the destination in the MPP (provided the MPP already includes the destination). In this instance, a location is designated as the destination of travel at which the vehicle, after reaching it, stands still at least long enough so that the components of the vehicle are able to cool off. The horizon provider may also ascertain alternative routes which the driver could also select. The concept MPP is then used as a substitute for the most probable route and possible alternative routes.

The horizon provider supplies attributes along the MPP, which include the probable speed behavior along the MPP and the position and type of traffic signs of the MPP. In next substep 22, a speed profile of the motor vehicle is ascertained, in which data on speed limits, gradients and curve curvatures along the MPP are taken into account. In a further substep 23, the vehicle mass, its rolling resistance coefficient, its resistance to flow coefficient and its projected frontal area are stored in the control unit as approximate vehicle parameters. Moreover, the air density is stored as an approximate environmental parameter. From all this, a running resistance equation is set up, from which the drive load for a fixed time grid is estimated in advance every 100 ms along the route. The electronic horizon includes information on the type of the road-surface covering, such as asphalt, concrete or gravel. These are taken into account in the ascertainment of the rolling resistance coefficient.

In a further substep 24, in order to improve the load prediction, in addition, a more accurate load profile is transmitted via the electronic horizon, which is set up by the horizon provider with the aid of prior trips. For this, the drive load is stored during each trip in a fixed time grid with locality relationship via GPS or compound position finding. If a route has been traveled several times, the drive load is able to be estimated using statistics on the past trips. In order to achieve that changes along the route, such as speed limits or changes in driving behavior, such as faster driving on a known stretch of road, are taken into account in the statistics, only the last ten trips on the route are drawn upon for the estimation. The load profile generated in this way is driver-dependent and vehicle-dependent.

In the following step 31, the prediction takes place of the drive load profile over the driving time, from the data provided in preceding data supply step 2. In the following, in step 32, there takes place an efficiency characteristics map-supported conversion of the load profile of the electrical drive of the hybrid electrical vehicle to the waste heat set free by the electrical machine and the inverter. In this case, negative loads generated by recuperation are also generated, which also place a demand on the electrical machine and the inverter. In following step 33 a prediction is made on the optimum energy driving strategy over time and route by torque subdivision between the internal combustion engine and the electrical drive.

Subsequently, in step 34, a measurement is made of the current critical component temperatures in the E-machine and in the inverter. From these data there takes place an extrapolation 35 of the further heating under the predicted load profile at the optimum energy driving strategy. For this purpose, there takes place an inclusion, by calculation, of thermal masses heating up of the waste heat set free and the heat dissipated via heat losses and cooling. In the prediction of the thermal load, the expected destination is taken into account. This enables a correction 36 of the torque subdivision to be made between the internal combustion engine and the E-machine with respect to avoiding a derating during high loads, so that at high loads the maximum drive power of the E-machine is available.

Finally, a corresponding control 37 of the internal combustion engine and the E-machine takes place, that is, a torque subdivision. Finally, there also takes place a checking 4, as to whether the driver is deviating from the predicted route. In that case, data supply step 2 is carried out again. Otherwise, the data of data supply step 2 are retained and a renewed prediction 31 takes place of the drive load profile. This makes it possible to update correction 36 of the torque subdivision every 10 seconds, for example. A more rapid updating is also possible according to the present invention. In that case, however, the torque subdivision may react too fast to fluctuating input values.

What is claimed is:

1. A method for controlling an internal combustion engine and an E-machine of an hybrid electrical vehicle, the method comprising:
controlling the internal combustion engine as a function of a current waste heat and an expected waste heat of an electrical drive of the hybrid electrical vehicle.

2. The method of claim 1, wherein the current waste heat of the electrical drive is determined by measuring at least one critical component temperature in the E-machine and/or in an inverter of the electrical drive.

3. The method of claim 1, wherein the expected waste heat of the electrical drive is ascertained by an efficiency characteristics map-supported conversion of a load profile of a predicted route.

4. The method of claim 3, wherein the predicted route is ascertained by a horizon provider.

5. The method of claim 4, wherein the most probable route of travel, inclusive of alternative possibilities, is ascertained by the horizon provider.

6. The method of claim 3, wherein the load profile is determined using a speed profile, that is estimated by data of an electronic horizon, using a driving resistance equation, at least the following parameters being taken into account: the vehicle mass, the rolling resistance coefficient, the resistance to flow coefficient, the projected frontal area of the vehicle and the air density.

7. The method of claim 6, wherein in a calculation of the rolling resistance coefficient, the type of road-surface covering is taken into account, and wherein the data on the road-surface covering is provided by the electronic horizon.

8. The method of claim 1, wherein the predicted travel route is ascertained based on a plurality of stored travel routes that have already been traveled.

9. The method of claim 1, wherein a torque subdivision between the internal combustion engine and the E-machine is updated at specified time intervals.

10. A computer readable medium having a computer program, which is executable by a processor, comprising:
a program code arrangement having program code controlling an internal combustion engine and an E-machine of an hybrid electrical vehicle, by performing the following:
controlling the internal combustion engine as a function of a current waste heat and an expected waste heat of an electrical drive of the hybrid electrical vehicle.

11. The computer readable medium of claim 10, wherein the current waste heat of the electrical drive is determined by measuring at least one critical component temperature in the E-machine and/or in an inverter of the electrical drive.

12. A control unit to control an internal combustion engine of an hybrid electrical vehicle, comprising:
a control arrangement for controlling the internal combustion engine and an E-machine of an hybrid electrical vehicle, by performing the following:
controlling the internal combustion engine as a function of a current waste heat and an expected waste heat of an electrical drive of the hybrid electrical vehicle.
